(19) United States
(12) Patent Application Publication
(10) Pub. No.: US 2015/0088347 A1
(43) Pub. Date: Mar. 26, 2015

(54) DRIVING MODE SWITCHING DEVICE FOR ELECTRIC GEAR BOX

(71) Applicant: TSENG-FU YEH, KAOHSIUNG CITY (TW)

(72) Inventor: TSENG-FU YEH, KAOHSIUNG CITY (TW)

(21) Appl. No.: 14/037,656

(22) Filed: Sep. 26, 2013

(51) Int. Cl. B60K 6/50; H02K 7/116

(52) U.S. Cl. CPC B60K 6/50; H02K 7/116; Y10S 903/902
USPC 701/22; 74/421 A; 74/661; 180/65.22; 903/902

(57) ABSTRACT

A driving mode switching device for an electric gear box includes a body having a room and a clutch member is located in the room. A first active gear and a second active gear are located in the room, the first and second active gears are co-axially connected to each other. The second active gear is engaged with a passive gear which is co-axially connected with a transmission gear. A motor unit has an output shaft located in the room. The output shaft has a toothed portion engaged with the first active gear. The motor unit drives the first and second active gears. The passive gear drives the transmission gear. The clutch member shifts the passive gear axially to disengage the passive gear from the second active gear. The body is connected to and provides power to a bicycle, a motorcycle, or a tri-wheel vehicle.

### FIELD OF THE INVENTION

The present invention relates to a driving mode switching device, and more particularly, to a driving mode switching device for an electric gear box used on a bicycle or a motorcycle.

### BACKGROUND OF THE INVENTION

Cycling becomes a popular exercise to people living in the urban areas and the bicycles are developed to have different features for different purposes. There are mountain bikes, folding bicycles, racing bicycles, or lady bicycles. In order to have higher efficiency of performance, some of the bicycles are equipped with a derailleur system so as to adjust the desired speed and save the riders effort. However, the conventional derailleur systems are mechanical systems which require the riders to tread the pedals very hard when the low-speed gear is used, and this is not suitable for elders and kids. Electrical riding system is developed which is cooperated with an electronic gear box and can reach high speed. Nevertheless, the rotation of the cranks is also increased along with the speed, if the rider treads the pedals in reverse direction, the bicycle could flip over and cause injury to the rider.

The present invention intends to provide a driving mode switching device for an electric gear box so as to improve the shortcomings mentioned above.

### SUMMARY OF THE INVENTION

The present invention relates to a driving mode switching device for an electric gear box and comprises a body having a room defined therein and a clutch member located in the room, a first active gear and a second active gear located in the room, the first and second active gears co-axially connected to each other, the second active gear engaged with a passive gear which is co-axially connected with a transmission gear. A motor unit has an output shaft which is located in the room, wherein a toothed portion is defined in an end of the output shaft and engaged with the first active gear. Thereby, the motor unit drives the output shaft and the toothed portion drives the first active gear which drives the second active gear. The passive gear drives the transmission gear. The clutch member shifts the passive gear axially a distance to disengage the passive gear from the second active gear.

In a driving mode switching device for an electric gear box, the first and second active gears are mounted to a first shaft, the passive gear is mounted to a second shaft which protrudes from the body and is connected to the transmission gear.

In a driving mode switching device for an electric gear box, the second shaft has a narrow section and a first resilient member is mounted to the narrow section.

In a driving mode switching device for an electric gear box, the clutch member has a control member and a stop member, the control member is radially connected to the stop member, the control member drives the stop member which contacts the passive gear and moves the passive gear axially.

In a driving mode switching device for an electric gear box, a cover is connected to the body and has a through hole, a recess is defined in an inside of the cover.

In a driving mode switching device for an electric gear box, the clutch member has a control member and a stop member, the control member is radially connected to the stop member, the stop member extends through the through hole of the cover and has an extension portion which is located in opposite to the control member, the extension portion is engaged with the recess in the cover.

In a driving mode switching device for an electric gear box, the stop member has a second resilient member which is located corresponding to the through hole of the cover.

In a driving mode switching device for an electric gear box, the body is connected to a bicycle which has a transmission member and a chain which is connected to the transmission member, the transmission gear is connected to the chain.

In a driving mode switching device for an electric gear box, the body is connected to a motorcycle which has a driving member, the transmission gear is connected to the driving member, the motor unit providing power to the transmission gear to move the motorcycle via the driving member.

In a driving mode switching device for an electric gear box, the driving member is a speed changing device and the transmission gear is connected to the driving member by a chain.

In a driving mode switching device for an electric gear box, the motorcycle has an input member which is connected to an engine of the motorcycle and the motor unit respectively so as to switch motorcycle to an engine-driving status or a motor-driving status for the motorcycle.

In a driving mode switching device for an electric gear box, the motorcycle has a processing unit which is connected to a sensor and a control member respectively, the processing unit defines a pre-set speed, the sensor senses a speed of the motorcycle, the control member is connected to the engine of the motorcycle and the motor unit respectively, when the processing unit judges that a speed of the motorcycle is higher than the pre-set speed, the control member switches the motorcycle to be the engine-driving status, when the processing unit judges that a speed of the motorcycle is lower than the pre-set speed, the control member switches the motorcycle to be the motor-driving status.

In a driving mode switching device for an electric gear box, the pre-set speed is 60 kilometers per hour.

In a driving mode switching device for an electric gear box, the motorcycle has a first handle and a second handle, the first handle controls the motorcycle to be operated under the engine-driving status, the second handle controls the motorcycle to be operated under the motor-driving status.

The present invention comprises a clutch member which changes the engagement between the passive gear and the second active gear, and controls the transmission gear. The body is connected to and provides power to a bicycle or a motorcycle to easily control the driving modes thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the driving mode switching device of the present invention;

FIG. 2 shows that the cover is removed from the driving mode switching device of the present invention;

FIG. 3 is a front view of the driving mode switching device of the present invention;

FIG. 4 shows the operative status of the driving mode switching device of the present invention;

FIG. 5 is a cross sectional view, taken along line A-A in FIG. 1;

FIG. 6 shows the engagement between the passive gear and the second active gear of the driving mode switching device of the present invention;

FIG. 7 shows the disengagement between the passive gear and the second active gear of the driving mode switching device of the present invention;

FIG. 8 shows another operative status of the driving mode switching device of the present invention, and

FIG. 9 shows the block diagram of the driving mode switching device of the present invention used to a motorcycle.

### DETAILED DESCRIPTION OF THE PREFERRED EMBODIMENT

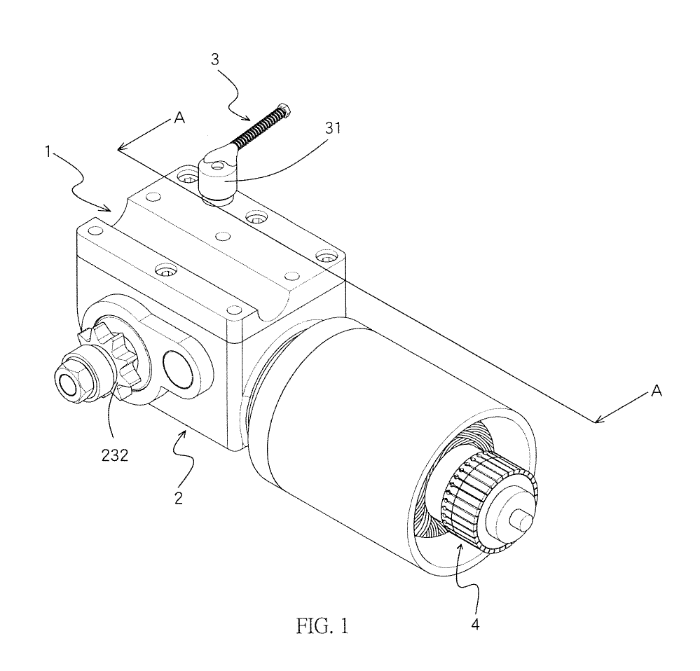

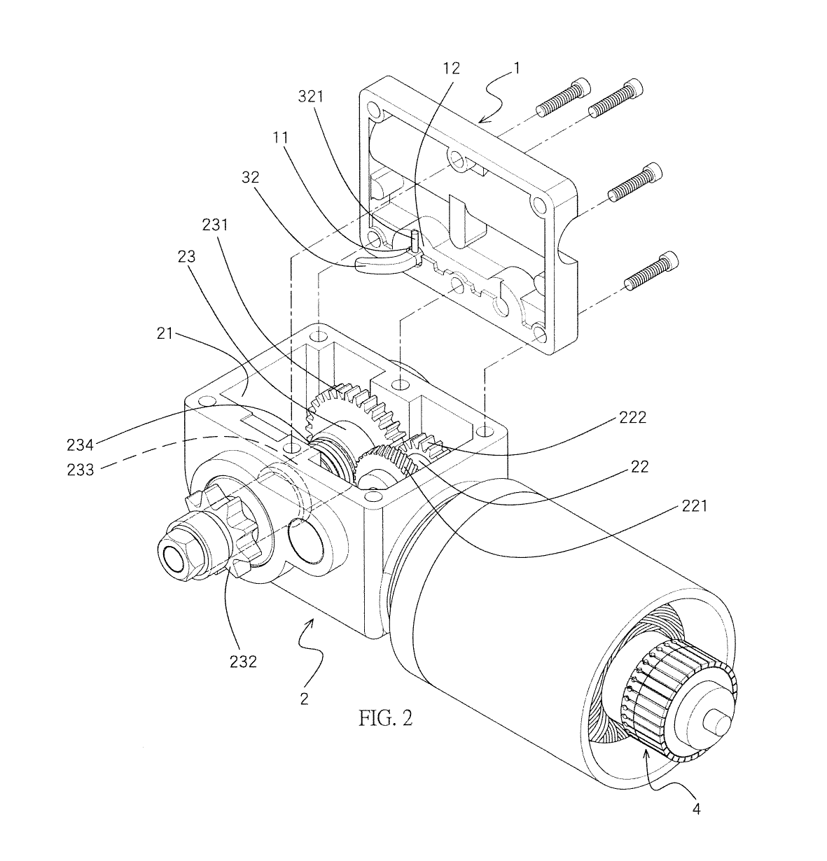

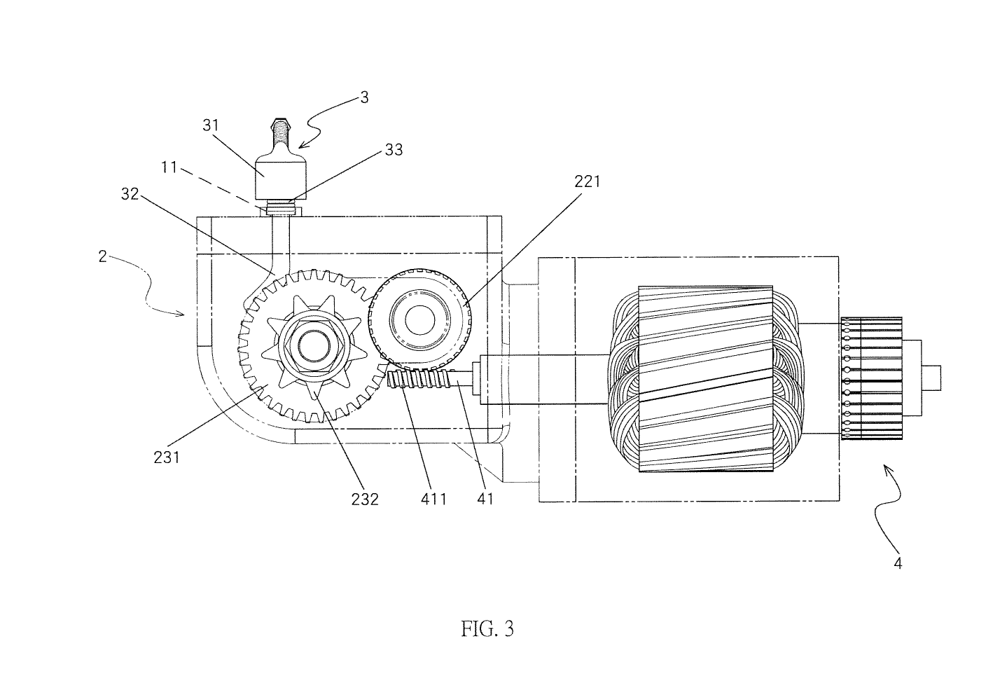

Referring to FIGS. 1 to 3, the driving mode switching device of the present invention comprises a cover 1 having a through hole 11 and a recess 12 is defined in the inside of the cover 1.

A body 2 is connected with the cover 1 so as to define a room 21 and a clutch member 3 is located in the room 21. A first shaft 22 and a second shaft 23 are located in the room 21, and the first and second shafts 22, 23 are parallel to each other. A first active gear 221 is mounted to the first shaft 22, and a passive gear 231 is mounted to the second shaft 23. The first and second active gears 221, 222 co-axially connected to each other. The passive gear 231 is engaged with the second active gear 222. The second shaft 23 protrudes from the body 2 and a transmission gear 232 is connected to the protruding portion of the second shaft 23. The second shaft 23 has a narrow section 233 and a first resilient member 234 is mounted to the narrow section 233.

The clutch member 3 has a control member 31 and a stop member 32, wherein the control member 31 is radially connected to the stop member 32. The stop member 32 extends through the through hole 11 of the cover 1, and has a second resilient member 33 located corresponding to the through hole 11. The stop member 32 has an extension portion 321 which is located in opposite to the control member 31. The extension portion 321 is engaged with the recess 12 in the cover 1.

A motor unit 4 has an output shaft 41 which is located in the room 21. A toothed portion 411 is defined in one end of the output shaft 41 and engaged with the first active gear 221.

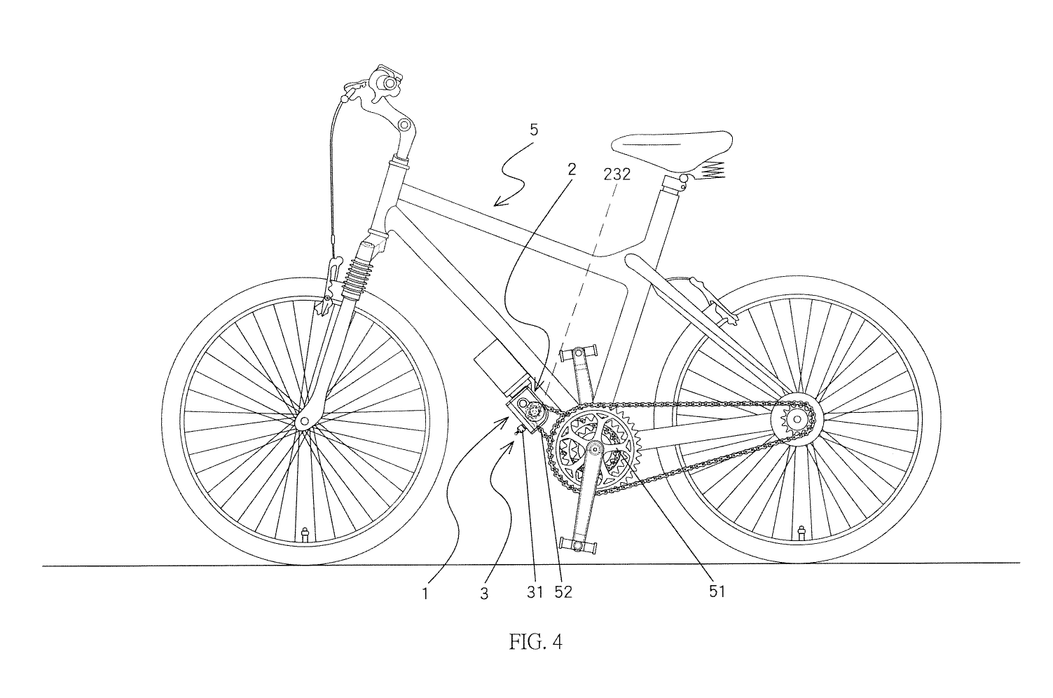

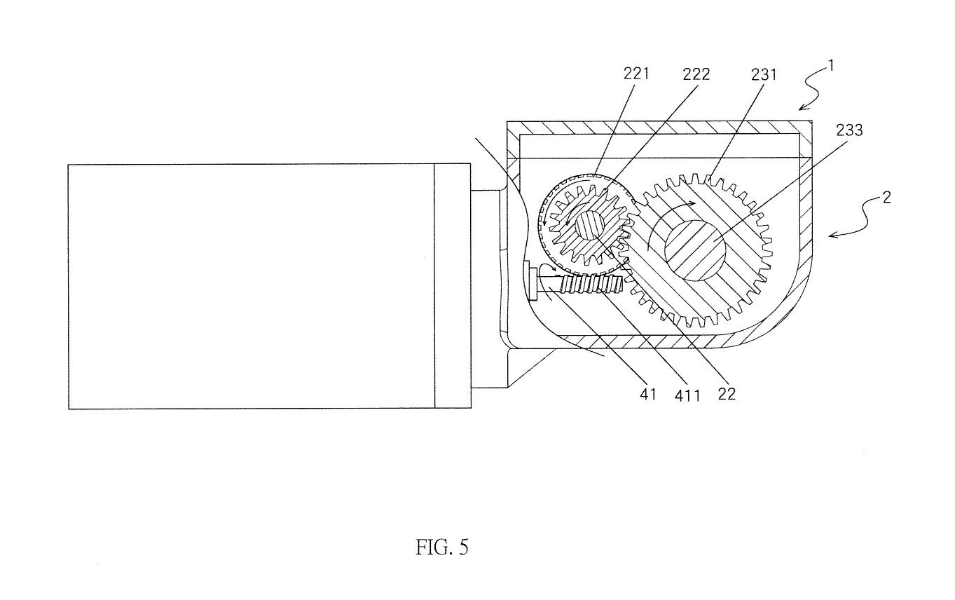

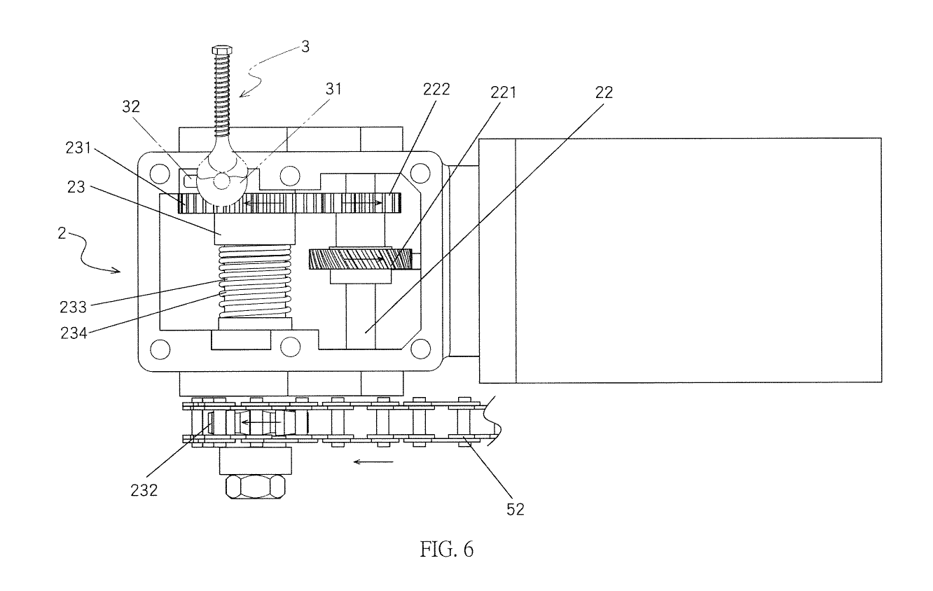

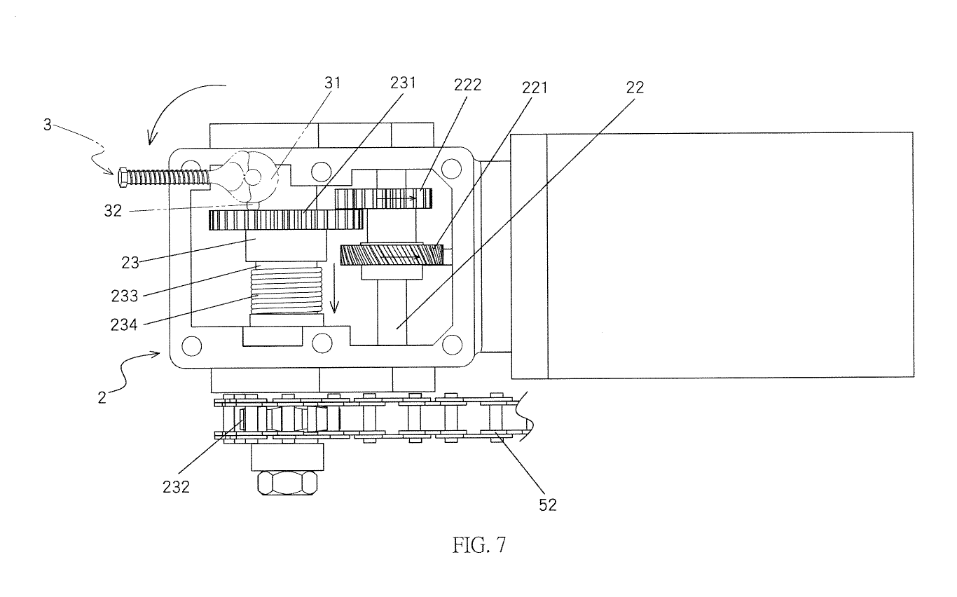

As shown in FIGS. 4 to 7, the body 2 is connected to a bicycle 5 which has a transmission member 51 and a chain 52 connected to the transmission member 51. The transmission gear 232 is connected to the chain 52. The transmission member 51 is a gear cluster which can be directly connected to the control unit of the bicycle 5 so as to switch the gears. The motor unit 4 drives the output shaft 41 and the toothed portion 411 drives the first active gear 221 which drives the second active gear 222 simultaneously. The passive gear 231 drives the transmission gear 232 as shown in FIG. 5. The first and second active gears 221, 222 rotate in the same direction. The rotation direction of the passive gear 231 is opposite to that of the first and second active gears 221, 222. Because the transmission gear 232 is connected to the chain 52 so that the bicycle 5 is driven to move forward. When the clutch member 3 shifts the passive gear 231 axially, the passive gear 231 is disengaged from the second active gear 222, so that the transmission gear 232 is not under action. In other words, the rider controls the clutch member 3 to let the control member 31 to drive the stop member 32. The present invention utilizes torque principle to save the user's effort. When the stop member 32 contacts the passive gear 231 and pushes the passive gear 231 a distance axially, the first resilient member 234 is compressed. The passive gear 231 and the second active gear 222 are disengaged from each other, so that the transmission gear 232 cannot drive the bicycle 5 to move forward.

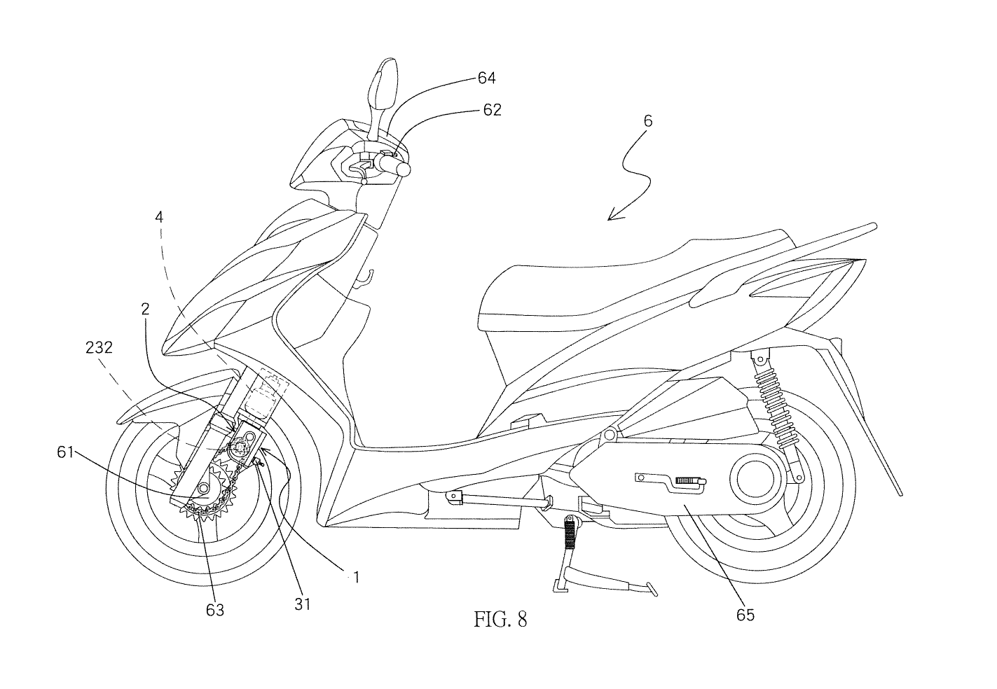

As shown in FIG. 8 which shows another embodiment of the use of the driving mode switching device, the body 2 is connected to a motorcycle 6 wherein the motorcycle 6 can be the regular motorcycle, a tri-wheel vehicle, or even an abandoned motorcycle. The motorcycle 6 has a driving member 61 which is a speed changing device which can be directly connected to the switch member 62 of the motorcycle 6 to change the gears manually. The transmission gear 232 is connected to the driving member 61 by a chain 63 so that the motor unit 4 provides power to the transmission gear 232 to move the motorcycle 6 via the driving member 61.

The motorcycle 6 has an input member 64 which is connected to the engine 65 of the motorcycle 6 and the motor unit 4 respectively so as to switch to an engine-driving status or a motor-driving status for the motorcycle 6. The input member 64 can be a touch screen device.

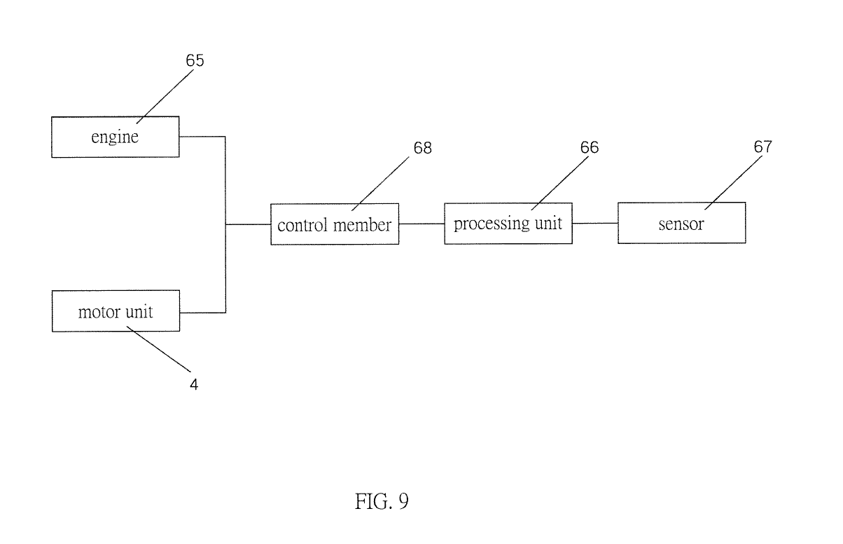

When the driving mode switching device is used to the motorcycle 6, the motorcycle 6 has two driving modes so that the rider can switch the two modes manually by the input member 64. As shown in FIG. 9, the present invention has an auto-mode to switch the two driving modes of the motorcycle 6. The auto-mode further comprises a processing unit 66 which is connected to a sensor 67 and a control member 68 respectively. The processing unit 66 defines a pre-set speed which is 60 kilometers per hour (km/hr). The sensor 67 senses the speed of the motorcycle 6. The control member 68 is connected to the engine 65 of the motorcycle 6 and the motor unit 4 respectively. When the processing unit 66 judges that the speed of the motorcycle 6 is higher than the pre-set speed, the control member 68 switches the motorcycle 6 to be the engine-driving status. When the processing unit 66 judges that the speed of the motorcycle 6 is lower than the pre-set speed, the control member 68 switches the motorcycle 6 to be the motor-driving status.

Under the auto-mode, the sensor 67 detects and the processing unit 66 judges the speed of the motorcycle 6 relative to the pre-set speed. When the processing unit 66 judges that the speed of the motorcycle 6 is higher than the pre-set speed, the control member 68 switches the motorcycle 6 to be the engine-driving status. In other words, when the actual speed of the motorcycle 6 is higher than 60 km/hr, the control member 68 automatically switches the motorcycle 6 to be the engine-driving status which means the engine uses gas to generate power to drive the motorcycle 6.

When the processing unit 66 judges that the speed of the motorcycle 6 is lower than 60 km/hr, the control member 68 automatically switches the motorcycle 6 to be the motor-driving status which means that the driving power is supplied by electric power. In other words, the motorcycle 6 is powered by either gas or electric power.

It is noted that the motorcycle 6 has manual switching mode by the input member 64, and the auto-mode by the processing unit 66, the motorcycle 6 has a first handle and a second handle. The first handle controls the motorcycle 6 to be operated under the engine-driving status, the second handle controls the motorcycle 6 to be operated under the motor-driving status. In this embodiment, the first handle is the right handle of the motorcycle 6 and the second handle is the left handle of the motorcycle 6. The rider can operates either the left or the right handles to operate the motor-driving status or the engine-driving status.

When compared with the conventional switching device, the clutch member 3 of the present invention has a control member 31 and a stop member 32, wherein the control member 31 controls the stop member 32 to contact the passive gear 231 so as to move the second shaft 23 move axially along the narrow section 233 so as to simultaneously move the passive gear 231 to change the engagement status between the passive gear 231 and the second active gear 222, and to control the operation of the transmission gear 232. Furthermore, the present invention can also be used to a bicycle 5 and the transmission gear 232 is connected to the chain 52. By the clutch member 3, the operation status of the transmission gear 232 can be changed according to the practical needs to control the movement of the bicycle 5. The body 2 can also be connected to the regular motorcycle, the tri-wheel vehicles or even abandoned motorcycle to provide power to those vehicle or motorcycles, such that these vehicle or motorcycles have two different operation modes which are the engine-driving mode and the motor-driving mode. The operation modes to the motorcycles or vehicle can be made by manual operation of the input member 64, the auto-mode from the processing unit 66, or the operation to either the left or right handle.

While we have shown and described the embodiment in accordance with the present invention, it should be clear to those skilled in the art that further embodiments may be made without departing from the scope of the present invention.

1. A driving mode switching device for an electric gear box, comprising:
a housing having an inner space defined therein;
a first active gear and a second active gear located in the inner space, the first and second active gears being co-axially connected with each other on a first shaft, a passive gear co-axially disposed with a transmission gear for rotation therewith, the passive gear being displaceable between axially displaced engaged and disengaged positions with respect to the second active gear, the passive gear being resiliently biased to one of the engaged and disengaged positions;
a motor unit having an output shaft located in the inner space, a toothed portion defined at an end of the output shaft and engaged with the first active gear, the motor unit driving the output shaft and the toothed portion driving the first active gear to responsively drive the second active gear; and
a clutch member extending into the inner space, the clutch member being displaceable to selectively displace the passive gear between the engaged and disengaged positions relative to the second active gear.

2. The device as claimed in claim 1, wherein the passive gear is mounted on a second shaft, the second shaft protruding from the housing and being connected to the transmission gear.

3. The device as claimed in claim 2, wherein the second shaft has a narrow section and a first resilient member is mounted to the narrow section.

4. The device as claimed in claim 1, wherein the clutch member has a control member and a stop member, the control member is radially connected to the stop member, the control member drives the stop member which contacts the passive gear and moves the passive gear axially.

5. The device as claimed in claim 1, wherein a cover is connected to the body and has a through hole, and a recess is defined in an inside of the cover.

6. The device as claimed in claim 5, wherein the clutch member has a control member and a stop member, the control member is radially connected to the stop member, the stop member extends through the through hole of the cover and has an extension portion which is located in opposite to the control member, the extension portion is engaged with the recess in the cover.

7. The device as claimed in claim 6, wherein the stop member has a second resilient member which is located corresponding to the through hole of the cover.

8. The device as claimed in claim 1, wherein the housing is connected to a bicycle which has a transmission member and a chain which is connected to the transmission member, the transmission gear is connected to the chain.

9. The device as claimed in claim 1, wherein the housing is connected to a motorcycle which has a driving member, the transmission gear is connected to the driving member, the motor unit providing power to the transmission gear to move the motorcycle via the driving member.

10. The device as claimed in claim 9, wherein the driving member is a speed changing device and the transmission gear is connected to the driving member by a chain.

11. The device as claimed in claim 9, wherein the motorcycle has an input member which is connected to an engine of the motorcycle and the motor unit respectively so as to switch motorcycle to an engine-driving status or a motor-driving status for the motorcycle.

12. The device as claimed in claim 9, wherein the motorcycle has a processing unit which is connected to a sensor and a control member respectively, the processing unit defines a pre-set speed, the sensor senses a speed of the motorcycle, the control member is connected to the engine of the motorcycle and the motor unit respectively, when the processing unit judges that a speed of the motorcycle is higher than the pre-set speed, the control member switches the motorcycle to be the engine-driving status, when the processing unit judges that a speed of the motorcycle is lower than the pre-set speed, the control member switches the motorcycle to be the motor-driving status.

13. The device as claimed in claim 12, wherein the pre-set speed is 60 kilometers per hour.

14. The device as claimed in claim 9, wherein the motorcycle has a first handle including a first input member and a second handle including a second input member, wherein the first input member is connected to an engine of the motorcycle and the second input member is connected to the motor unit, the first handle controls the motorcycle to be operated under the engine-driving status, the second handle controls the motorcycle to be operated under the motor-driving status.
